(19) United States
(12) Patent Application Publication
(10) Pub. No.: US 2018/0347945 A1
(43) Pub. Date: Dec. 6, 2018

(54) Optical Sight with a Device for Indicating a Turn of a Rectifier and with a Zero Stop Function

(71) Applicant: Meopta - Optika, s.r.o., Prerov (CZ)

(72) Inventors: Roman Burianec, Hranice (CZ); Jaroslav Struzka, Prerov (CZ); Antonin Zdrahala, Radotin (CZ)

(21) Appl. No.: 16/001,065

(22) Filed: Jun. 6, 2018

(30) Foreign Application Priority Data
Jun. 6, 2017 (CZ) PV 2017-322

(51) Int. Cl. F41G 1/38; F41G 1/54; G05G 1/10

(52) U.S. Cl. CPC F41G 1/38; G05G 1/10; F41G 1/545

(57) ABSTRACT

The invention relates to an optical sight with a device for indicating a turn of a rectifier and with a zero stop function, which comprises a longitudinal body (1), in which are mounted elements of the sight, which are coupled to at least one mechanism of the rectifier (2), which comprises a control element (20) to be used by the sight user for manual control, whereby the rectifier (2) is provided with a turn indicator (21) of the rectifier (2), which protrudes from the upper surface (200) of the rectifier (2) and which is coupled to a mechanism of turn identification of the rectifier (2). The indicator (21) comprises a longitudinal identification protrusion (210), which is by its length (L) located in a direction along the upper surface (200) of the rectifier (2) and which is rotatable about the axis OI, which is perpendicular to the length (L) of the longitudinal identification protrusion (210) and at the same time is parallel to the axis (OP) of rotation of the control element (20) of the rectifier (2), whereby the longitudinal identification protrusion (210) is rotatable about the axis OI between its basic position and its turned position, the longitudinal identification protrusion (210) being associated with a coding means (211), which is mounted on the upper surface (200) of the rectifier (2) and is located above the upper surface of the longitudinal identification protrusion (210).

### TECHNICAL FIELD

The invention relates to an optical sight with a device for indicating a turn of a rectifier with a built-in zero stop function, the optical sight comprising a longitudinal body, in which are mounted elements of the sight coupled to at least one mechanism of the rectifier, which comprises a rotatable control element to be used by the sight user for manual control, whereby the rectifier is equipped with an indicator of the turn of the rectifier, which protrudes from the upper surface of the rectifier and which is coupled to a mechanism for identifying the rectifier turn.

### BACKGROUND ART

In optical sights, such as optical sights used on rifles, etc., mechanisms are used which allow to correct the settings of the optical sight. In general, these mechanisms are called rectifiers.

The mechanism of a rectifier is integrated into a body of an optical sight and is connected to the element or system of elements of the optical sight which is being set. The mechanism of the rectifier is manually operated by means of a rotatable element mounted on the body of the sight. Some elements of the sight require a wider or finer range of setting, or it is the users of such sights that require a larger or finer range of setting. In order to meet this requirement, the entire working range of the element of the sight being set is controlled within two turns of the rotatable element of the rectifier, i.e. within the rotation range greater than 360°. To avoid mistakes of the user caused by not knowing whether he or she is moving during the setting of the rectifier within the first turn of the rectifier (or its control element) or within the second turn of the rectifier, these rectifiers are provided with the so-called rectifier turn indicator. The rectifier turn indicator is a mechanism which is coupled to the rotatable element of the rectifier or the rectifier mechanism, and when the rectifier moves from the first turn to the second turn, it provides information (visual, tactile) which makes it possible to readily detect this transition of the rectifier from first to second turn and back.

Well-known solutions of sights with rectifier turn indicators can be divided into two groups, whereby one group allows purely visual control of the rectifier turn, while the other group allows combined representation of the rectifier turn in the form of visual and tactile check. Using a tactile check is important especially in difficult visual conditions, such as at night and in situations when, for example, the user cannot use light to check the turn indicator because he or she does not want to reveal his or her presence or position, etc.

There are numerous well-known solutions which allow combined representation of the rectifier turn, for example the solutions known from US 2008/0236018, U.S. Pat. No. 7,612,952, U.S. Pat. No. 8,516,736, U.S. Pat. No. 8,312,667 and US 2003/0140545. One of the best-known solution is the solution in which during the transition between the first and second turn of the rectifier, axial or radial extension (or insertion) of an identifying means (identifier) occurs, e.g. in the form of a pin or pins, or an axial extension of a ring into an annulus, another option being mutual rotation of the rings, etc.

Moreover, the mechanism of the rectifier is usually combined with the so-called “zero stop” function, which enables to set and lock the zero position of the rectifier according to the user's current needs, so that if the need arises to reset the rectifier completely, the user can return the rectifier easily, comfortably and reliably to this zero position, from which a new setting of the rectifier will start.

A common disadvantage of the solutions of the background art is a relatively complicated construction, which, in addition, generally requires the transfer of the rotary motion of the rectifier control element to the linear reciprocating motion of the rectifier turn identification element (identifier) being ejected and inserted.

The aim of the invention is therefore to eliminate or at least to reduce the drawbacks of the background art.

### PRINCIPLE OF THE INVENTION

The aim is achieved by an optical sight with a device for indicating a turn of a rectifier with a built-in zero stop function, whose principle consists in that the indicator comprises a longitudinal identification protrusion, which is by its length located in a direction along the upper surface of the rectifier and which is rotatable about the axis OI, which is perpendicular to the length of the longitudinal identification protrusion and at the same time parallel to the axis of rotation of the rectifier control element, whereby the longitudinal identification protrusion is rotatable about the axis OI between its basic position and its turned position, the longitudinal identification protrusion being associated with a coding means, which is mounted on the upper surface of the rectifier and is located above the upper surface of the longitudinal identification protrusion.

The advantages of this solution include user-friendly identification of the current state of the rectifier control element, namely the indication of the rectifier turn, as well as simple design and realization of the zero stop function.

### DESCRIPTION OF DRAWINGS

The invention is schematically represented in the drawings, wherein

FIG. 1 shows an overall view of the sight according to the invention with a detail of the rectifier turn identifier in position 1,

FIG. 1a is a detailed view of FIG. 1,

FIG. 2 is an overall view of the sight according to the invention with a detail of the rectifier turn identifier in position 2,

FIG. 2a is a detailed view of FIG. 2,

FIG. 3 is a plan view of the arrangement of the positioning mechanism of the identifier at top dead center of the rectifier control element (maximum turn of the rectifier control element),

FIG. 4 shows a plan view of the arrangement of the positioning mechanism of the identifier in the middle position of the rectifier control element, i.e. during the transition from one turn to another,

FIG. 5 shows is a plan view of the arrangement of the positioning mechanism of the identifier at bottom dead center (initial state) of the rotation of the rectifier control element (minimum turn—zero turn—turn of the rectifier control element—position for setting the “zero stop” function),

FIG. 6 is a cross-sectional view of the arrangement according to FIG. 3,

FIG. 7 is a cross-sectional view of the arrangement according to FIG. 4,

FIG. 8 is a cross-sectional view of the arrangement according to FIG. 5,

FIG. 9 is a cross-sectional view of the device according to the invention with locking bolts of the rectifier for setting the “zero stop” function and finally,

FIG. 10 shows an alternative embodiment of the connection of a quarter Maltese cross with the longitudinal identification protrusion by means of an axial pin on a shaft.

### EXAMPLES OF EMBODIMENT

The invention will be described with reference to an exemplary embodiment of an optical sight with a device for indicating a turn of a rectifier with a built-in zero stop function, the optical sight comprising a longitudinal body 1, in which individual unillustrated elements of the sight are mounted.

The elements of the sight which can be set by the user when using the sight are coupled to mechanisms of rectifiers 2, which are mounted on a body 1. The rectifiers 2 comprise rotatable control elements 20, which are adapted to be used by the sight user for manual control.

At least one of the rectifiers 2 is provided with an indicator 21 of a turn of the rectifier 2, which protrudes from the upper surface 200 of the respective rectifier 2. The upper surface 200 of the respective rectifier 2 is either a part of the control element 20, turning together with it, or the upper surface 200 of the respective rectifier 2 is independent of the control element 20 and during the rotation of the control element 20 the upper surface 200 does not move.

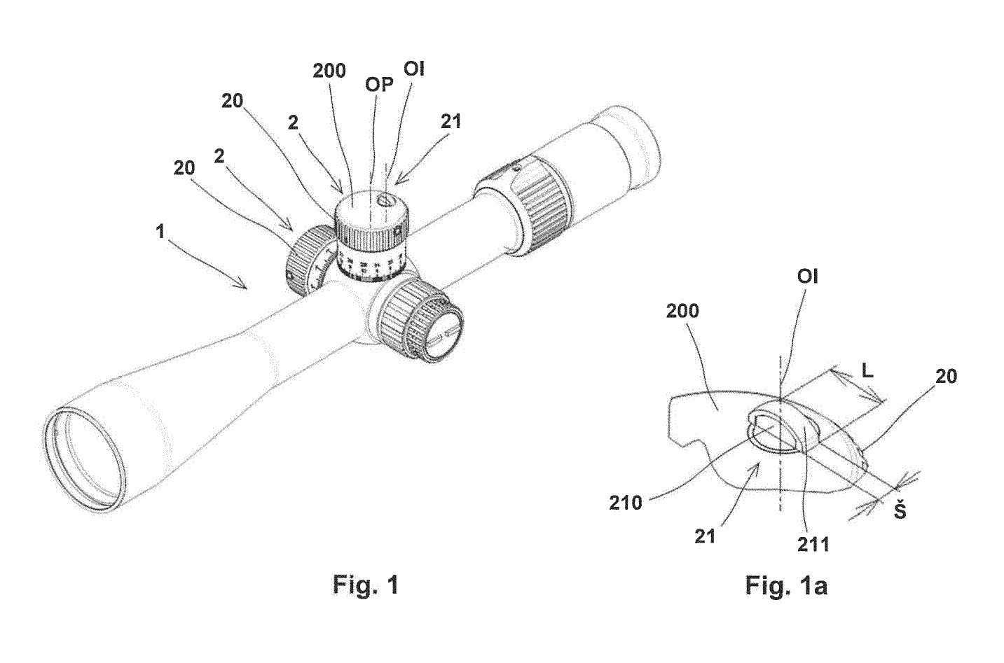

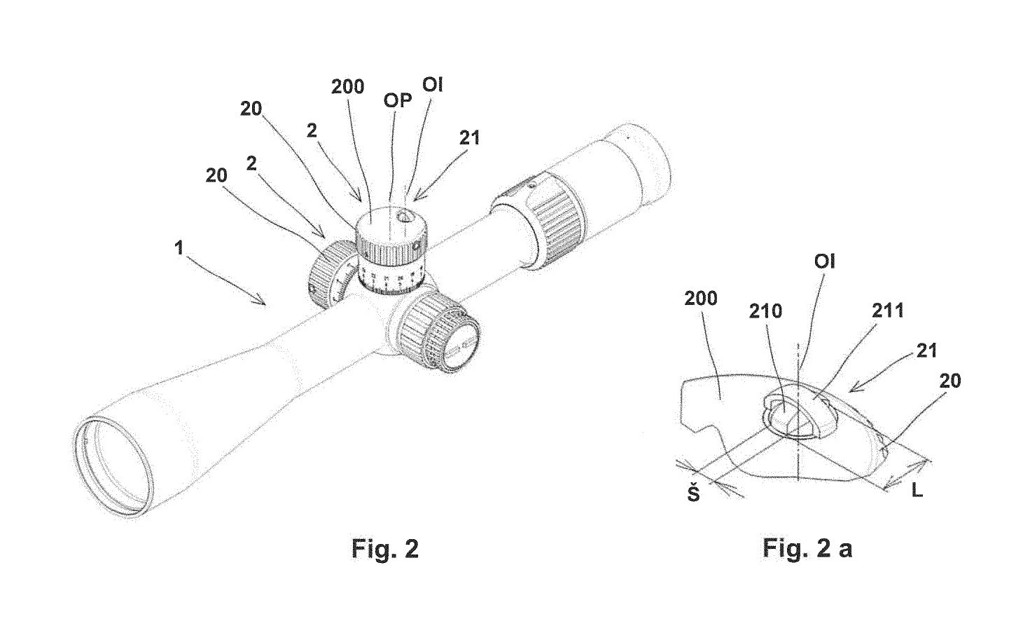

The indicator 21 comprises a longitudinal identification protrusion 210, located by its length L in the direction along the upper surface 200 of the rectifier 2. The longitudinal identification protrusion 210 has a width S. The longitudinal identification protrusion 210 is rotatable about the axis OI, which is perpendicular to the length L of the longitudinal identification protrusion 210 and at the same time parallel to the axis OP of rotation of the control element 20 of the rectifier 2. For this rotatable movement, the longitudinal identification protrusion 210 is coupled to a mechanism for identifying the rectifier 2 turn, which will be described in more detail hereinafter. The longitudinal identification protrusion 210 is rotatable about the axis OI between its basic position, see FIGS. 1 and 1a, which indicates the first turn of the rectifier 2 and the turned position, see FIGS. 2 and 2a, which indicates the second turn of the rectifier 2, or indicates that the rectifier 2 is within its second turn. Preferably, the longitudinal identification protrusion 210 turns by 90° between its two positions, as is apparent from FIGS. 1, 1a, 2 and 2a. In another embodiment, the size of this turn is different, but it is necessary that the size of this turn of the longitudinal identification protrusion 210 fulfills its purpose of reliable identification of the rectifier 2 transition between the first and second turns in connection with the coding means 211 of the longitudinal identification protrusion 210 which will be described below, and in accordance with the logics of identification in cooperation with the coding means 211.

The above-mentioned coding means 211 of the longitudinal identification protrusion 210 is fixedly mounted on the upper surface 200 of the rectifier 2, whereby in the illustrated example of embodiment it is formed by at least one longitudinal strip. The coding means 211 is located at a level above the upper surface of the longitudinal identification protrusion 210, whereby in one turned position of the longitudinal identification protrusion 210 the coding means 211 is, for example, situated in the direction of the length L of the longitudinal identification protrusion 210, which it practically overlaps in the illustrated example of embodiment—see FIGS. 1 and 1a, while in another turned position of the longitudinal identification protrusion 210 the coding means 211 is, for example, situated transversely to the direction of the length L of the longitudinal identification protrusion 210 and substantially forms a cross with the longitudinal identification protrusion 210, see FIGS. 2 and 2a. In principle, it is not important in which specific turned position of the longitudinal identification protrusion 210 this protrusion 210 is situated along the coding means and in which it is situated across the coding means 211 or it is situated, for example, in another mutually defined position.

The coding means 211 is, for example, formed by a shaped strip of a suitable material which by its bottom surface follows the shape of the upper surface of the longitudinal identification protrusion 210. Alternatively, the width of the coding means 211, or, more specifically, of the strip by which it is formed, corresponds to the width S of the longitudinal identification protrusion 210, SO that it would be possible to identify reliably—visually, but also tactilely—the mutual position of the longitudinal identification protrusion 210 and the coding means 211 and in this manner to determine accurately in which turn the rectifier 2 currently is. For easier visual control, the longitudinal identification protrusion 210 in the unillustrated example of embodiment is distinguished by its color from the coding means 211 and, if appropriate, also from the other elements of the rectifier 2.

The above-mentioned mechanism for identifying a turn of the rectifier 2, which ensures respective rotation of the longitudinal identification protrusion 210 depending on the current turn of the control element 20 of the rectifier 2, comprises a variation of a Maltese mechanism with a Maltese cross 3, whose rotatable motion, which is transferred onto the longitudinal identification protrusion 210, is evoked by a drive pin 4, and which is carried by the control element 20 of the rectifier 2.

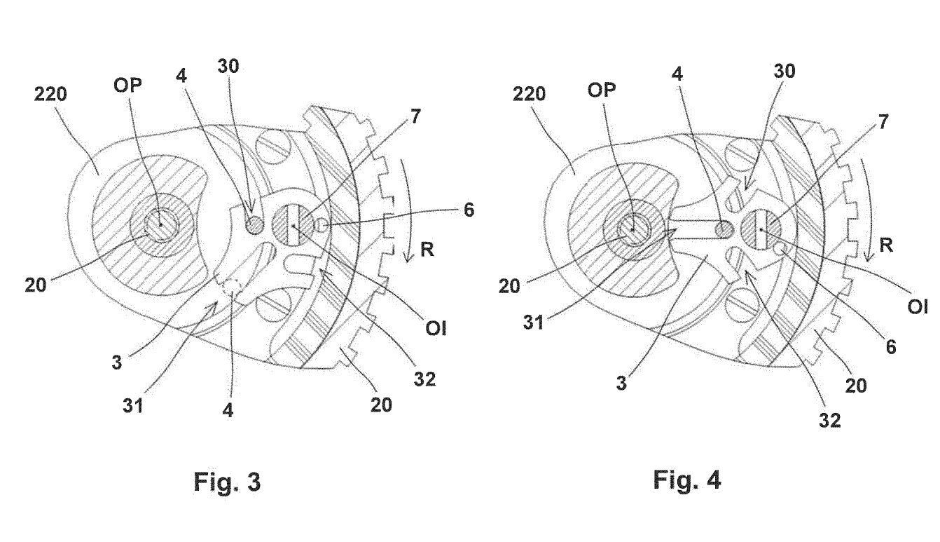

FIGS. 3 to 8 show an arrangement of the above-mentioned variant of the Maltese mechanism for transferring the rotatable motion of the control element 20 of the rectifier 2 onto the longitudinal identification protrusion 210. The Maltese cross 3 is rotatably mounted on the shaft 7, whereby the axis of rotation of the shaft 7 is identical to the axis of rotation OI of the longitudinal identification protrusion 210. The Maltese cross 3 is coupled to the longitudinal identification protrusion 210 by a pin 6, which is by one of its ends eccentrically mounted in the Maltese cross 3 and by its other end is eccentrically mounted in the longitudinal identification protrusion 210. The Maltese cross 3 is provided with three grooves 30, 31, 32, which are arranged with respect to one another at angular spacing and which are designed to cooperate with the drive pin 4, which is carried by the control element 20 of the rectifier 2 in the direction of the arrow R and against this direction R. In the schematic representation of FIG. 10, the Maltese cross 3 is coupled to the longitudinal identification protrusion 210 by means of an axial pin on the shaft 7.

The function of the mechanism is as follows.

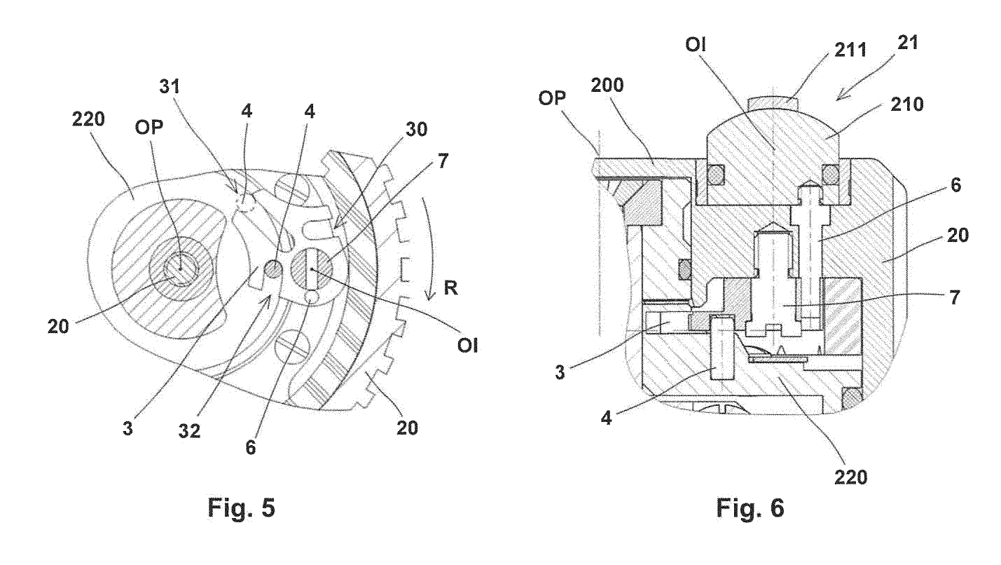

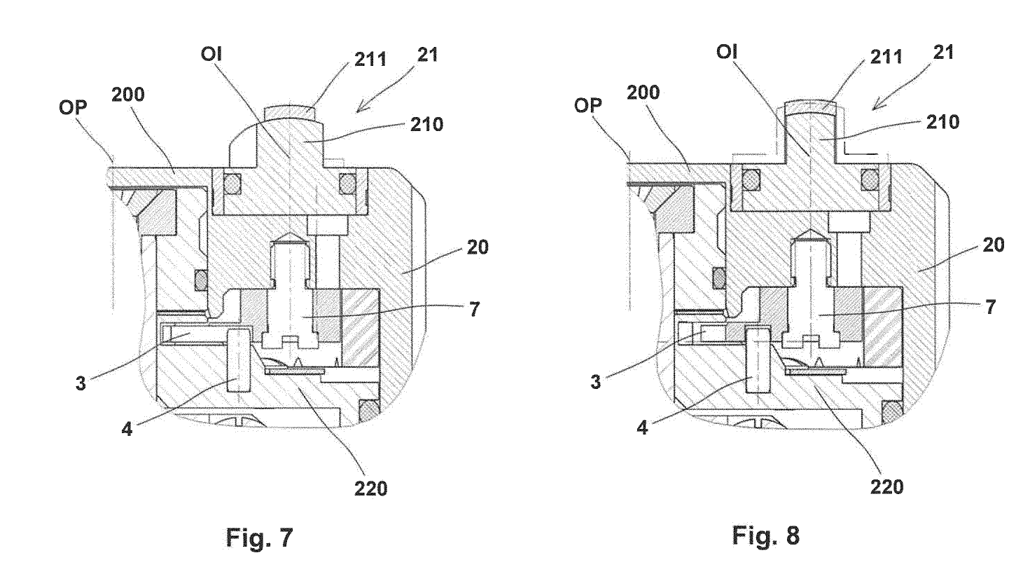

FIG. 3 and FIG. 6 show the rectifier 2 set in the uppermost position (at top dead center), i.e., in the illustrated example of embodiment at the beginning of the first turn of the rectifier 2. In this position, the drive pin 4, which is accommodated in the housing 220 of the rectifier 2, is engaged into the first groove 30 of the Maltese cross 3, which is rotatably mounted on the shaft 7. In addition, the axis of rotation of the shaft 7 is the same as the axis of rotation OI of the longitudinal identification protrusion 210 and the longitudinal identification protrusion 210 is located along the coding means 211, see FIG. 1. Transferring the rotation of the Maltese cross 3 about the axis of rotation of the shaft 7 to the longitudinal identification protrusion 210 is secured by the pin 6, which is by one of its ends mounted in the Maltese cross 3 and by its other end it is mounted in the longitudinal identification protrusion 210, as shown in FIG. 6. When the control element 20 of the rectifier 2 is turning together with the Maltese cross 3 towards the so-called second turn of the rectifier 2 at first the Maltese cross 3 moves out of its position with the drive pin 4 in the first groove 30 of the Maltese cross 3 in the direction of the arrow R and before completing the first turn of the control element 20 of the rectifier 2 the middle groove 31 of the Maltese cross 3 moves onto the drive pin 4, as indicated by a dashed ring in FIG. 3. As the control element 20 of the rectifier 2 continues to turn, the Maltese cross 3 is turned by the drive pin 4 into the position in FIG. 4, which is the position of the transition to the second turn of the rectifier 2. This rotation of the Maltese cross 3 is transferred through the pin 6 to the longitudinal identification protrusion 210, which also slightly turns. At this stage, the state of the transition of the rectifier 2 from the first to the second turn is indicated, which is shown in FIG. 4 and FIG. 7. This state is also indicated by the fact that the longitudinal identification protrusion 210 has slightly turned and is now situated obliquely with respect to the coding means 211, that is, in a kind of an intermediate position between the indication of the rectifier 2 in the first turn according to FIGS. 1 and 1a and the indication of the rectifier 2 in the second turn according to FIGS. 2 and 2a. With the control element 20 of the rectifier 2 continuing to turn towards the end of the second turn of the rectifier 2 the Maltese cross 3 is further turned by the drive pin 4, assuming the position with the drive pin indicated by a dashed ring in FIG. 5, by which means the longitudinal identification protrusion 210 completes its rotation, assuming the position shown in FIGS. 2 and 2a. Due to further rotation of the rectifier 2 the drive pin 4 indicated by the dashed ring in FIG. 5, moves out of the middle groove 31 of the Maltese cross 3, the control element 20 together with the Maltese cross 3 completes an entire circle in the direction of the arrow R and before the completion of this circuit, the third groove 32 of the Maltese cross 3 moves onto the drive pin 4, as is indicated by a full hatched ring in FIG. 5, whereby the drive pin 4 further prevents movement of the third groove 32, thereby blocking further rotation of the control element 20 of the rectifier 2, which is at this stage at the end of the second turn (at bottom dead center of the mechanism). This final state is shown in FIG. 5 and FIG. 8.

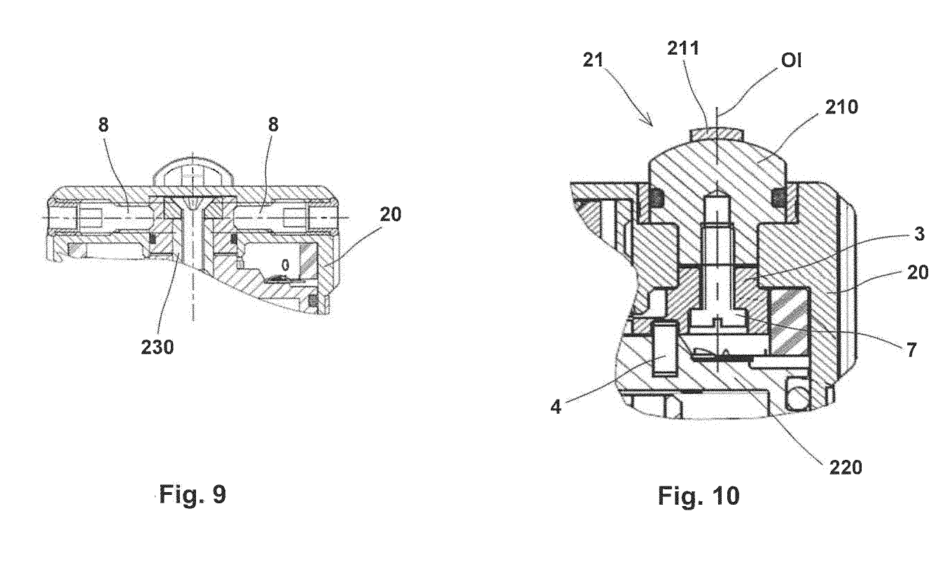

At top dead center is also employed the “zero stop” function of the control element 20 of the rectifier 2, which is in the illustrated exemplary embodiment achieved by the mechanism described above. The “zero stop” function of the control element 20 of the rectifier 2 is based on the fact that a fixed starting point of the gun when zeroing the weapon is created, which allows the shooter to return the control 20 of the rectifier 2 always to the same initial (zero) position. The “zero stop” position must be set after the rectification and firing the weapon. A change in the setting of the “zero stop” position is in the solution according to the invention implemented by means of at least one locking bolt 8, see FIG. 9, which is transversely screwed in the control element 20 of the rectifier 2, and which in its locked position abuts with its face the sidewall of the rectifying screw 230, locking (in its locked position) or releasing (in its released position) the mutual rotational movement of the rectifying screw 230 and the control element 20 of the rectifier 2. Releasing the locking bolts 8 leads to releasing the connection of the rectifying screw 230 and the control element 20 of the rectifier 2, whereupon by rotation of the control element 20 of the rectifier 2 “to the stop”, the initial (zero) position of the control element 20 of the rectifier 2 together with the Maltese cross 3 is set relative to the housing 220 along with the drive pin 4. In this position, the locking bolts 8 are tightened again, thereby securing this initial position fulfilling the “zero stop” function for the entire mechanism according to the invention.

In an unillustrated example of embodiment, the modified Maltese mechanism is provided with a plurality of grooves to accommodate the drive pin 4 the grooves being directed to each other, which enables to display a greater number of the turns of the rectifier 2 than the basic 2 turns, for which purpose is adapted the shape and design of the longitudinal identification protrusion 210 and the coding means 211, especially due to the fact that the longitudinal identification protrusion 210 must assume a greater number of positions slightly turned relative to the coding means 211 than the basic 2 positions described herein, and, moreover, it is essential that the greater number of the mutual positions of the longitudinal identification protrusion 210 and of the coding means 211 are reliably recognized by the user both visually and tactilely in conditions of reduced visibility or even in complete darkness.

1. An optical sight with a device for indicating a turn of a rectifier and with a zero stop function, which comprises a longitudinal body (1) in which are mounted elements of the sight, which are coupled to at least one mechanism of the rectifier (2), which comprises a rotatable control element (20) to be used by the sight user for manual control, whereby the rectifier (2) is provided with an indicator (21) of a turn of the rectifier (2), which protrudes from the upper surface (200) of the rectifier (2) and which is coupled to a mechanism identifying a turn of the rectifier (2), characterized in that the indicator (21) comprises a longitudinal identification protrusion (210), which is located by its length (L) in the direction along the upper surface (200) of the rectifier (2) and which is rotatable about the axis OI, which is perpendicular to the length (L) of the longitudinal identification protrusion (210) and at the same time is parallel to the axis (OP) of rotation of the control element (20) of the rectifier (2), whereby the longitudinal identification protrusion (210) is rotatable about the axis OI between its basic position and its slightly turned position, whereby the longitudinal identification protrusion (210) is associated with a coding means (211), which is mounted on the upper surface (200) of the rectifier (2) and is located above the upper surface of the longitudinal identification protrusion (210).

2-10. (canceled)
